(19) United States
(12) Patent Application Publication
(10) Pub. No.: US 2002/0079760 A1
(43) Pub. Date: Jun. 27, 2002

(54) Double diaphragm coumpound shaft

(75) Inventor: Phillip B. Vessa, Thousand Oaks, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Capstone Turbine Corporation, Chatsworth, CA (US)

(21) Appl. No.: 09/984,799

(22) Filed: Oct. 31, 2001

Related U.S. Application Data
(60) Provisional application No. 60/245,014, filed on Oct. 31, 2000.

(51) Int. Cl. H02K 7/00

(52) U.S. Cl. 310/75 D

(57) ABSTRACT

A compound shaft coupling having a flexible disk shaft, with two flexible diaphragms, and two shafts. One flexible disk diaphragm is coupled with an interference fit to the first shaft, while the other flexible disk diaphragm is removably coupled by a female multi-lobe connector to a matching multi-lobe male connector on the second stiff shaft. Alternatively, the male connector may be on the flexible disk diaphragm and the female connector on the second stiff shaft. A quill shaft connects the two flexible disk diaphragms. The first shaft maybe a hollow sleeve with a magnet mounted therein and the second shaft may include a compressor wheel, a bearing rotor, and a turbine wheel removably mounted on a tie bolt shaft. The turbine wheel may be solid with the tie bolt attached thereto or formed integral therewith.

### REFERENCE TO RELATED APPLICATION

This application claims the benefit of priority under 35 USC 119(e) of U.S. Provisional Application No. 60/245,014, filed on Oct. 31, 2000, which provisional application is incorporated by reference herein in its entirety.

### TECHNICAL FIELD

This invention relates to the general field of shafts for rotating machinery and, more particularly, to an improved shaft therefor.

### BACKGROUND OF THE INVENTION

In rotating machinery, various rotating elements such as compressors, turbines, fans, generators, and motors are affixed to a shaft upon which they rotate. The shaft can be a single piece unitary structure or it can be a compound structure having two or more shaft elements connected by one or more coupling elements. What is needed is a technique for coupling multi element compound shafts to permit easy assembly and disassembly with minimal use of lubricants or coatings between mating surfaces.

### SUMMARY OF THE INVENTION

In a first aspect, the present invention provides a compound shaft including:

a quill shaft having a first flexible disk at a first end thereof and a second flexible disk at a second end thereof; and

a first stiff shaft, the first flexible disk interference fit with the first stiff shaft;

and a second stiff shaft, the second stiff shaft having an end comprising a first multi-lobe male or female connector; and

a second multi-lobe female or male connector on the second flexible disk drivingly mating with the first multi-lobe male or female connector.

In another aspect, the present invention provides a compound shaft for a permanent magnet turbogenerator, the compound shaft including:

and a quill shaft having a first flexible disk at a first end thereof and a second flexible disk at a second end thereof, and

the turbogenerator having a first stiff shaft, the first flexible disk interference fit with the first stiff shaft, and the

turbogenerator having a second stiff shaft, the second stiff shaft having an end comprising a first multi-lobe male or female connector, and

a second multi-lobe female or male connector on the second flexible disk drivingly mating with said first multi-lobe male or female connector.

In another aspect, the present invention provides a method of making a compound shaft with the following steps:

providing a quill shaft having a first flexible disk at a first end thereof and a second flexible disk at a second end thereof, and;

providing a first stiff shaft, and;

attaching said first flexible disk by an interference fit with said first stiff shaft and;

providing a second stiff shaft and;

providing on the second stiff shaft having an end comprising a first multi-lobe male or female connector; and

providing a second multi-lobe female or male connector on the second flexible disk drivingly mating with the first multi-lobe male or female connector.

In another aspect, the present invention provides a method of making a compound shaft for a permanent magnet turbogenerator, having the steps of:

providing a quill shaft having a first flexible disk at a first end thereof and a second flexible disk at a second end thereof and;

providing the turbogenerator with a first shaft and;

attaching the first flexible disk by an interference fit with the first shaft and;

providing the turbogenerator with a second shaft and;

providing on the second shaft an end comprising a first multi-lobe male or female connector; and

providing a second multi-lobe female or male connector on said second flexible disk drivingly mating with the first multi-lobe male or female connector.

In the present invention, the compound shaft generally comprises a first shaft rotatably supported by a pair of journal bearings, a second shaft rotatably supported by a single journal bearing and by a bidirectional thrust bearing, and a flexible disk shaft having two flexible disk diaphragms. One flexible disk diaphragm of the flexible disk shaft is coupled with an interference fit to the first shaft. The other flexible diaphragm is coupled with a snug or slightly loose fit by a multi-lobe female connector to a multi-lobe male connector on the second stiff shaft. A quill shaft connects the two flexible disk diaphragms of the flexible disk shaft.

The flexible disk shaft allows the compound shaft to tolerate relatively large misalignments of the three journal bearings from a straight line axis.

The first shaft can be a hollow sleeve with a magnet for a permanent magnet generator/motor mounted therein. This permanent magnet shaft can have its sleeve's outer diameter serve as both the generator/motor rotor outer diameter and as the rotating surface for the two spaced compliant foil hydrodynamic fluid film journal bearings mounted at the ends of the permanent magnet shaft. The second shaft may include a compressor impeller, a bearing rotor, and a turbine wheel removably mounted on a tie bolt shaft. The turbine wheel may have a solid hub integrally connected to the head end of the tie bolt shaft. The tie bolt may be formed as one piece with the turbine wheel hub, welded thereto, or otherwise attached to the turbine wheel hub.

The method and apparatus of the present disclosure allows for angular misalignment of the generator/motor section rotor and compressor/turbine section rotor.

The method and apparatus of the present disclosure allows for increased de-coupling of the two rotor sections.

The method and apparatus of the present disclosure a allows for rapid assembly and disassembly of the two rotor sections without special tooling or other considerations.

The method and apparatus of the present disclosure allows for the incorporation of boreless turbine rotor designs.

The method and apparatus of the present disclosure minimize loose components at the interface of the two rotor sections that could become dislodged and ingested into the compressor intake (inducer). The ingestion of any foreign material could cause serious damage to the turbogenerator system and could prevent its operation.

The method and apparatus of the present disclosure allows for additional flexibility when performing maintenance on the generator/motor stator and related components.

The method and apparatus of the present disclosure allows for ease of design change to either of the rotor sections.

The method and apparatus of the present disclosure allows for a coupling that can connect two rotor sections, operating at high rotational speeds, without lubrication at the contact surfaces.

### BRIEF DESCRIPTION OF THE DRAWINGS

Having described the present invention in general terms, reference will now be made to the accompanying drawings in which:

FIG. 1A is perspective view, partially in section, of an integrated turbogenerator system.

FIG. 1B is a magnified perspective view, partially in section, of the motor/generator portion of the integrated turbogenerator of FIG. 1A.

FIG. 1C is an end view, from the motor/generator end, of the integrated turbogenerator of FIG. 1A.

FIG. 1D is a magnified perspective view, partially in section, of the combustor-turbine exhaust portion of the integrated turbogenerator of FIG. 1A.

FIG. 1E is a magnified perspective view, partially in section, of the compressor-turbine portion of the integrated turbogenerator of FIG. 1A.

FIG. 2 is a block diagram schematic of a turbogenerator system including a power controller having decoupled rotor speed, operating temperature, and DC bus voltage control loops.

FIG. 3 is a cross-sectional view illustrating the flexible disk shaft between the generator/motor section and the compressor/combustor section.

FIG. 4 is an enlarged section of a connection between one end of the flexible disk shaft and an outer section of the compressor impeller hub.

FIG. 5 illustrates a tri-lobe configuration of a female connector usable in the connection illustrated in FIG. 4.

FIG. 6 is an illustration of quad-lobe configuration of a female connector usable in the connection illustrated in FIG. 4.

### MECHANICAL STRUCTURAL EMBODIMENT OF A TURBOGENERATOR

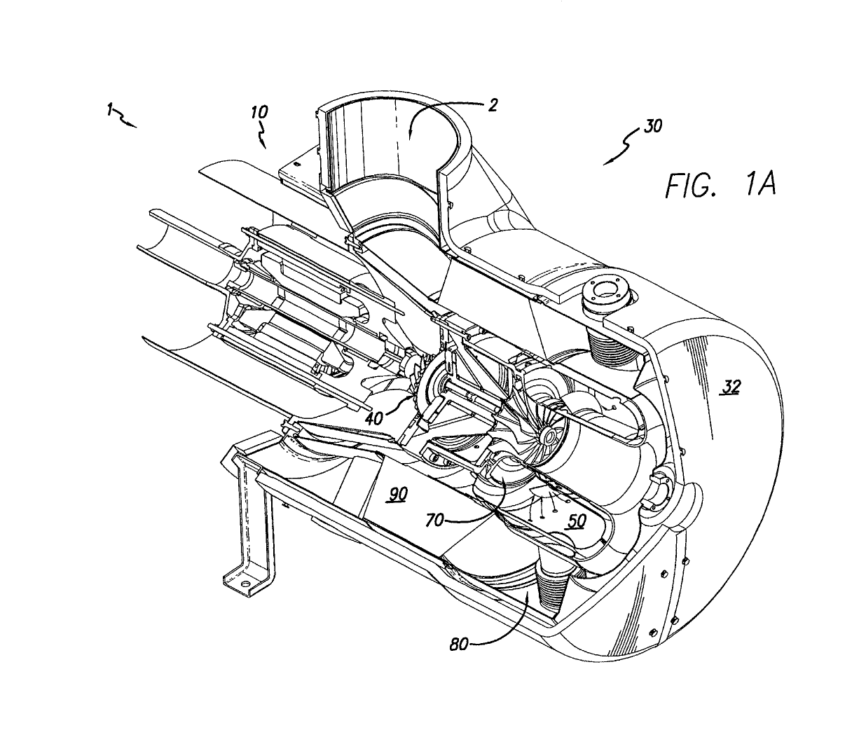

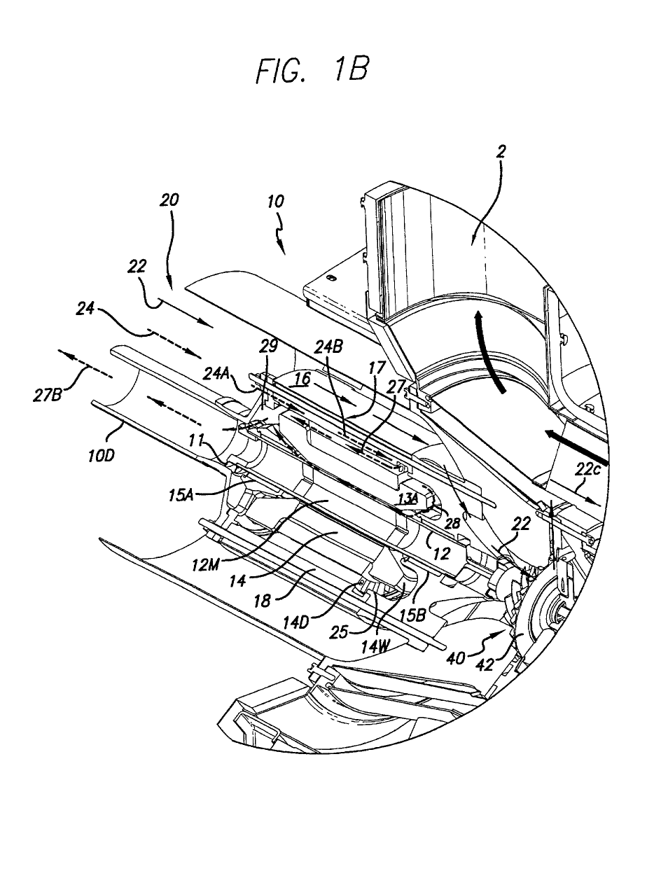

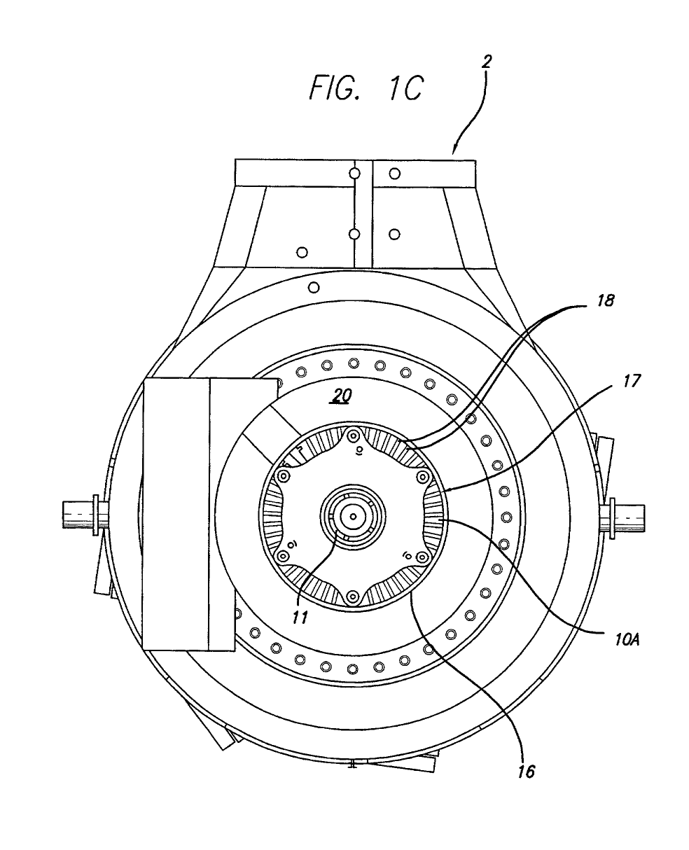

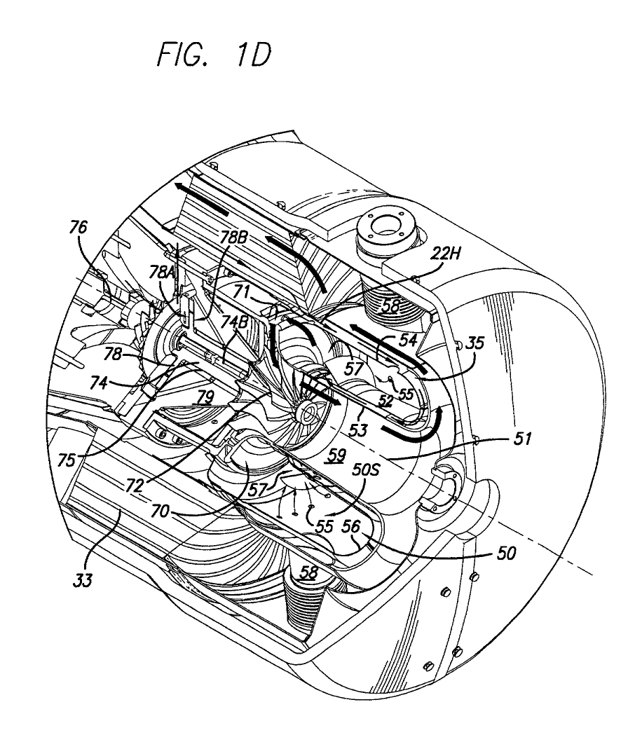

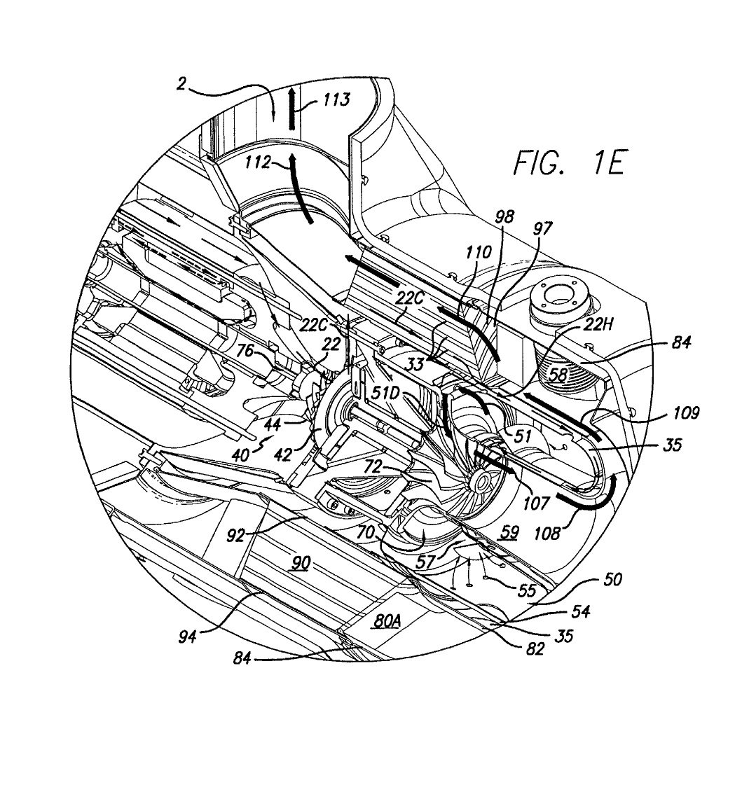

With reference to FIG. 1A, an integrated turbogenerator 1 according to the present invention generally includes motor/generator section 10 and compressor-combustor section 30. Compressor-combustor section 30 includes exterior can 32, compressor 40, combustor 50 and turbine 70. A recuperator 90 may be optionally included.

Referring now to FIG. 1B and FIG. 1C, in a currently preferred embodiment of the present invention, motor/generator section 10 may be a permanent magnet motor generator having a permanent magnet rotor or sleeve 12. Any other suitable type of motor generator may also be used. Permanent magnet rotor or sleeve 12 may contain a permanent magnet 12M. Permanent magnet rotor or sleeve 12 and the permanent magnet disposed therein are rotatably supported within permanent magnet motor/generator stator 14. Preferably, one or more compliant foil, fluid film, radial, or journal bearings 15A and 15B rotatably support permanent magnet rotor or sleeve 12 and the permanent magnet disposed therein. All bearings, thrust, radial or journal bearings, in turbogenerator 1 may be fluid film bearings or compliant foil bearings. Motor/generator housing 16 encloses stator heat exchanger 17 having a plurality of radially extending stator cooling fins 18. Stator cooling fins 18 connect to or form part of stator 14 and extend into annular space 10A between motor/generator housing 16 and stator 14. Wire windings 14W exist on permanent magnet motor/generator stator 14.

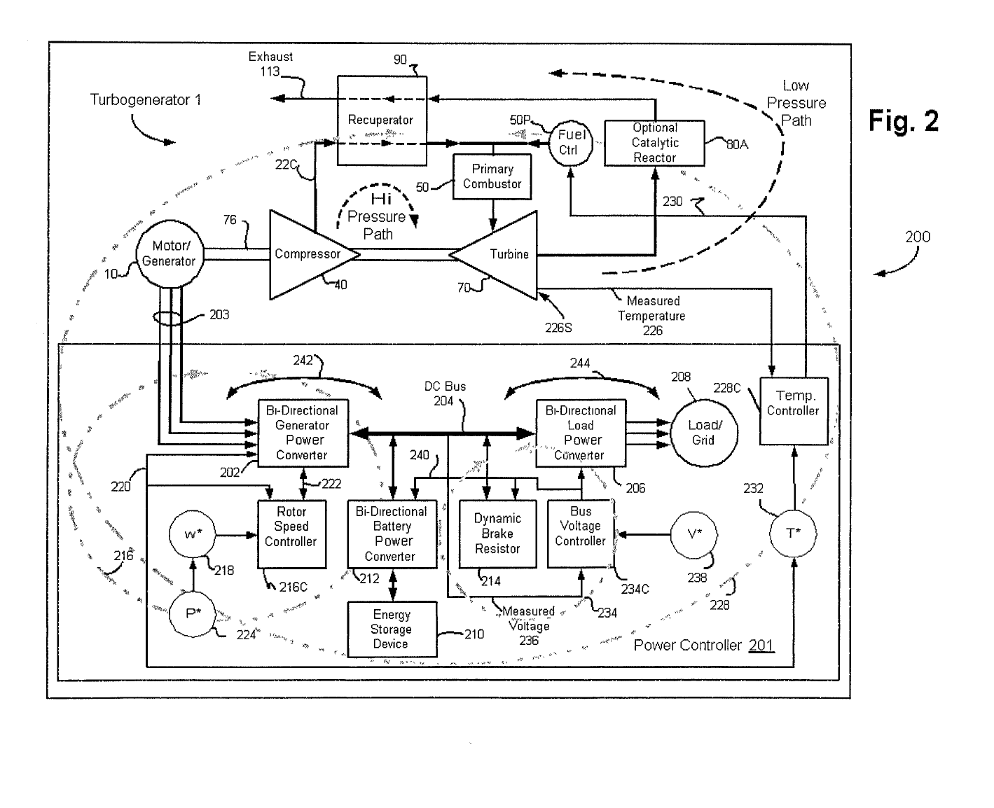

Referring now to FIG. ID, combustor 50 may include cylindrical inner wall 52 and cylindrical outer wall 54. Cylindrical outer wall 54 may also include air inlets 55. Cylindrical walls 52 and 54 define an annular interior space 50S in combustor 50 defining an axis 51. Combustor 50 includes a generally annular wall 56 further defining one axial end of the annular interior space of combustor 50. Associated with combustor 50 may be one or more fuel injector inlets 58 to accommodate fuel injectors which receive fuel from fuel control element 50P as shown in FIG. 2, and inject fuel or a fuel air mixture to interior of 50S combustor 50. Inner cylindrical surface 53 is interior to cylindrical inner wall 52 and forms exhaust duct 59 for turbine 70.

Turbine 70 may include turbine wheel 72. An end of combustor 50 opposite annular wall 56 further defines an aperture 71 in turbine 70 exposed to turbine wheel 72. Bearing rotor 74 may include a radially extending thrust bearing portion, bearing rotor thrust disk 78, constrained by bilateral thrust bearings 78A and 78B. Bearing rotor 74 may be rotatably supported by one or more journal bearings 75 within center bearing housing 79. Bearing rotor thrust disk 78 at the compressor end of bearing rotor 76 is rotatably supported preferably by a bilateral thrust bearing 78A and 78B. Journal or radial bearing 75 and thrust bearings 78A and 78B may be fluid film or foil bearings.

Turbine wheel 72, Bearing rotor 74 and Compressor impeller 42 may be mechanically constrained by tie bolt 74B, or other suitable technique, to rotate when turbine wheel 72 rotates. Mechanical link 76 mechanically constrains compressor impeller 42 to permanent magnet rotor or sleeve 12 and the permanent magnet disposed therein causing permanent magnet rotor or sleeve 12 and the permanent magnet disposed therein to rotate when compressor impeller 42 rotates.

Referring now to FIG. 1E, compressor 40 may include compressor impeller 42 and compressor impeller housing 44. Recuperator 90 may have an annular shape defined by cylindrical recuperator inner wall 92 and cylindrical recuperator outer wall 94. Recuperator 90 contains internal passages for gas flow, one set of passages, passages 33 connecting from compressor 40 to combustor 50, and one set of passages, passages 97, connecting from turbine exhaust 80 to turbogenerator exhaust output 2.

Referring again to FIG. 1B and FIG. 1C, in operation, air flows into primary inlet 20 and divides into compressor air 22 and motor/generator cooling air 24. Motor/generator cooling air 24 flows into annular space 10A between motor/generator housing 16 and permanent magnet motor/generator stator 14 along flow path 24A. Heat is exchanged from stator cooling fins 18 to generator cooling air 24 in flow path 24A, thereby cooling stator cooling fins 18 and stator 14 and forming heated air 24B. Warm stator cooling air 24B exits stator heat exchanger 17 into stator cavity 25 where it further divides into stator return cooling air 27 and rotor cooling air 28. Rotor cooling air 28 passes around stator end 13A and travels along rotor or sleeve 12. Stator return cooling air 27 enters one or more cooling ducts 14D and is conducted through stator 14 to provide further cooling. Stator return cooling air 27 and rotor cooling air 28 rejoin in stator cavity 29 and are drawn out of the motor/generator 10 by exhaust fan 11 which is connected to rotor or sleeve 12 and rotates with rotor or sleeve 12. Exhaust air 27B is conducted away from primary air inlet 20 by duct 10D.

Referring again to FIG. 1E, compressor 40 receives compressor air 22. Compressor impeller 42 compresses compressor air 22 and forces compressed gas 22C to flow into a set of passages 33 in recuperator 90 connecting compressor 40 to combustor 50. In passages 33 in recuperator 90, heat is exchanged from walls 98 of recuperator 90 to compressed gas 22C. As shown in FIG. 1E, heated compressed gas 22H flows out of recuperator 90 to space 35 between cylindrical inner surface 82 of turbine exhaust 80 and cylindrical outer wall 54 of combustor 50. Heated compressed gas 22H may flow into combustor 54 through sidewall ports 55 or main inlet 57. Fuel (not shown) may be reacted in combustor 50, converting chemically stored energy to heat. Hot compressed gas 51 in combustor 50 flows through turbine 70 forcing turbine wheel 72 to rotate. Movement of surfaces of turbine wheel 72 away from gas molecules partially cools and decompresses gas 51D moving through turbine 70. Turbine 70 is designed so that exhaust gas 107 flowing from combustor 50 through turbine 70 enters cylindrical passage 59. Partially cooled and decompressed gas in cylindrical passage 59 flows axially in a direction away from permanent magnet motor/generator section 10, and then radially outward, and then axially in a direction toward permanent magnet motor/generator section 10 to passages 98 of recuperator 90, as indicated by gas flow arrows 108 and 109 respectively.

In an alternate embodiment of the present invention, low pressure catalytic reactor 80A may be included between fuel injector inlets 58 and recuperator 90. Low pressure catalytic reactor 80A may include internal surfaces (not shown) having catalytic material (e.g., Pd or Pt, not shown) disposed on them. Low pressure catalytic reactor 80A may have a generally annular shape defined by cylindrical inner surface 82 and cylindrical low pressure outer surface 84. Unreacted and incompletely reacted hydrocarbons in gas in low pressure catalytic reactor 80A react to convert chemically stored energy into additional heat, and to lower concentrations of partial reaction products, such as harmful emissions including nitrous oxides (NOx).

Gas 110 flows through passages 97 in recuperator 90 connecting from turbine exhaust 80 or catalytic reactor 80A to turbogenerator exhaust output 2, as indicated by gas flow arrow 112, and then exhausts from turbogenerator 1, as indicated by gas flow arrow 113. Gas flowing through passages 97 in recuperator 90 connecting from turbine exhaust 80 to outside of turbogenerator 1 exchanges heat to walls 98 of recuperator 90. Walls 98 of recuperator 90 heated by gas flowing from turbine exhaust 80 exchange heat to gas 22C flowing in recuperator 90 from compressor 40 to combustor 50.

Turbogenerator 1 may also include various electrical sensor and control lines for providing feedback to power controller 201 and for receiving and implementing control signals as shown in FIG. 2.

### Alternative Mechanical Structural Embodiments of the Integrated Turbogenerator

The integrated turbogenerator disclosed above is exemplary. Several alternative structural embodiments are known.

In one alternative embodiment, air 22 may be replaced by a gaseous fuel mixture. In this embodiment, fuel injectors may not be necessary. This embodiment may include an air and fuel mixer upstream of compressor 40.

In another alternative embodiment, fuel may be conducted directly to compressor 40, for example by a fuel conduit connecting to compressor impeller housing 44. Fuel and air may be mixed by action of the compressor impeller 42. In this embodiment, fuel injectors may not be necessary.

In another alternative embodiment, combustor 50 may be a catalytic combustor.

In another alternative embodiment, geometric relationships and structures of components may differ from those shown in FIG. 1A. Permanent magnet motor/generator section 10 and compressor/combustor section 30 may have low pressure catalytic reactor 80A outside of annular recuperator 90, and may have recuperator 90 outside of low pressure catalytic reactor 80A. Low pressure catalytic reactor 80A may be disposed at least partially in cylindrical passage 59, or in a passage of any shape confined by an inner wall of combustor 50. Combustor 50 and low pressure catalytic reactor 80A may be substantially or completely enclosed with an interior space formed by a generally annularly shaped recuperator 90, or a recuperator 90 shaped to substantially enclose both combustor 50 and low pressure catalytic reactor 80A on all but one face.

Alternative Use of the Invention Other than in Integrated Turbogenerators

An integrated turbogenerator is a turbogenerator in which the turbine, compressor, and generator are all constrained to rotate based upon rotation of the shaft to which the turbine is connected. The invention disclosed herein is preferably but not necessarily used in connection with a turbogenerator, and preferably but not necessarily used in connection with an integrated turbogenerator.

### Turbogenerator System Including Controls

Referring now to FIG. 2, a preferred embodiment is shown in which a turbogenerator system 200 includes power controller 201 which has three substantially decoupled control loops for controlling (1) rotary speed, (2) temperature, and (3) DC bus voltage. A more detailed description of an appropriate power controller is disclosed in U.S. patent application Ser. No. 09/207,817, filed 12/08/98 in the names of Gilbreth, Wacknov and Wall, and assigned to the assignee of the present application which is incorporated herein in its entirety by this reference.

Referring still to FIG. 2, turbogenerator system 200 includes integrated turbogenerator 1 and power controller 201. Power controller 201 includes three decoupled or independent control loops.

A first control loop, temperature control loop 228, regulates a temperature related to the desired operating temperature of primary combustor 50 to a set point, by varying fuel flow from fuel control element 50P to primary combustor 50. Temperature controller 228C receives a temperature set point, T*, from temperature set point source 232, and receives a measured temperature from temperature sensor 226S connected to measured temperature line 226. Temperature controller 228C generates and transmits over fuel control signal line 230 to fuel pump 50P a fuel control signal for controlling the amount of fuel supplied by fuel pump 50P to primary combustor 50 to an amount intended to result in a desired operating temperature in primary combustor 50. Temperature sensor 226S may directly measure the temperature in primary combustor 50 or may measure a temperature of an element or area from which the temperature in the primary combustor 50 may be inferred.

A second control loop, speed control loop 216, controls speed of the shaft common to the turbine 70, compressor 40, and motor/generator 10, hereafter referred to as the common shaft, by varying torque applied by the motor generator to the common shaft. Torque applied by the motor generator to the common shaft depends upon power or current drawn from or pumped into windings of motor/generator 10. Bi-directional generator power converter 202 is controlled by rotor speed controller 216C to transmit power or current in or out of motor/generator 10, as indicated by bidirectional arrow 242. A sensor in turbogenerator 1 senses the rotary speed on the common shaft and transmits that rotary speed signal over measured speed line 220. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling generator power converter 202's transfer of power or current between AC lines 203 (i.e., from motor/generator 10) and DC bus 204. Rotary speed set point source 218 may convert to the rotary speed set point a power set point P* received from power set point source 224.

A third control loop, voltage control loop 234, controls bus voltage on DC bus 204 to a set point by transferring power or voltage between DC bus 204 and any of (1) Load/Grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236. Bus voltage controller 234C receives the measured voltage signal from voltage line 236 and a voltage set point signal V* from voltage set point source 238. Bus voltage controller 234C generates and transmits signals to bidirectional load power converter 206 and bidirectional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 201 regulates temperature to a set point by varying fuel flow, adds or removes power or current to motor/generator 10 under control of generator power converter 202 to control rotor speed to a set point as indicated by bi-directional arrow 242, and controls bus voltage to a set point by (1) applying or removing power from DC bus 204 under the control of load power converter 206 as indicated by bidirectional arrow 244, (2) applying or removing power from energy storage device 210 under the control of battery power converter 212, and (3) by removing power from DC bus 204 by modulating the connection of dynamic brake resistor 214 to DC bus 204.

### Mechanical Connection Between the Generator/motor Section and the Compressor/Combustor Section

The disclosed system may be used to couple rotary elements for easy assembly and dissembly. In a currently preferred embodiment, the disclosed system is may be used in devices that are used to generate electrical power for commercial uses, such as turbogenerator systems. Typically these devices consist of generator/motor section 10 supported on two (2) radial bearings 300, 301 and compressor/combustor section 30 that is supported on one (1) or two (2) radial bearings (not shown). The generator/motor rotor is typically a permanent magnet inserted into a non-magnetic sleeve 12. Compressor/combustor section 30 is typically comprised of compressor impeller 42 and turbine wheel 72, which are connected by bearing rotor 74. Bearing rotor 74 includes thrust disk 78, which in-conjunction with axial thrust bearings (not shown) controls the axial location of the rotating assembly. Generator/motor section 10 and compressor/combustor section 30 are coupled together using mechanical link or flexible disk shaft 76 and as such rotate as a single assembly.

The rotating-assembly of these devices tend to rotate at very high speeds, typically above 20,000 rpm and approaching 100,000 rpm in some cases. From a rotordynamics standpoint, as a rotor becomes longer or less stiff, the rotational speed where the bending modes occur decreases. It is desirable to have the first bending mode at least 25% above the maximum operating speed. As more and more requirements are placed on high speed rotating machinery the need for faster, longer rotors, becomes more desirable. To solve this problem, flex-couplers can be incorporated to increase the length of the rotor systems and transmit torque such that the bending modes are outside the operating speed. Examples of this can be found in U.S. Pat. Nos. 6,037,687, 5,964,663, and 5,697,848 each of which is incorporated herein by reference in its entirety. This allows the design of high-speed turbo machinery to be less constrained. A problem of assembly occurs when incorporating these devices in any significant production numbers such as with a boreless turbine rotor. Flexible disk shaft 76 described herein is intended to facilitate the assembly/disassembly of high-speed turbo machinery.

Flexure couplings have been difficult, costly, and time consuming to assemble and disassemble. Some designs make it impossible to disassemble without damaging one or both of the components to an unusable state. This has made it impractical for both development work where rapid turnaround of design changes are required, and production where rapid assembly is required to minimize assembly time and costs.

Flexible disk shaft 76 is intended to address the requirements and shortcomings described above. The design yields a functionally acceptable coupling that is forgiving in dynamics, angulation, and stiff rotation. The design incorporates many of the features and benefits described in Capstone Turbine Corporation U.S. Pat. No. 5,964,663 for a Double Diaphragm Compound Shaft.

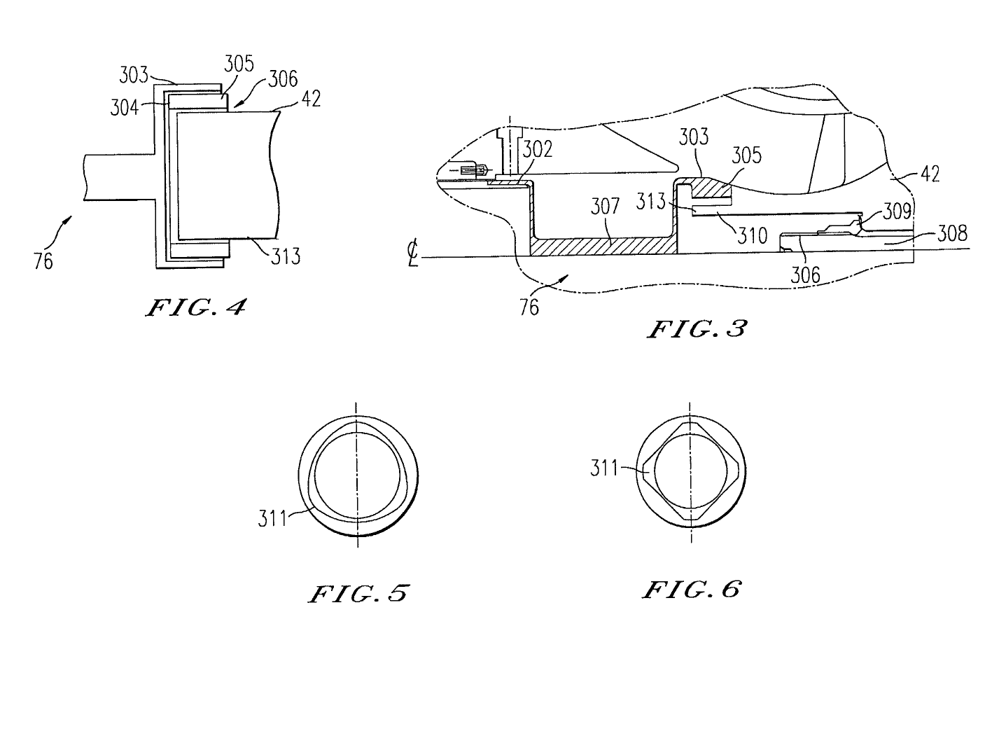

With reference to FIGS. 3-6, flexible disk shaft 76 has two thin diaphragms 302, 303 connected by small diameter quill shaft 307. Diaphragm 302 is attached to generator/motor rotor 12 with a radial press fit (i.e., interference fit). Diaphragm 303 is parallel and symmetrical about the centerline of the rotating assembly. Because the diaphragms are in series, the design offers transitional softness. Attached to the second diaphragm 303, by any of various methods, is ring 304. The ID (inner diameter) of ring 304 has a multi-lobed polygon shape machined into it (see FIGS. 5 and 6). The polygon may have different numbers of lobes 311 depending on the desired functions. For example, the polygon could be of a tri-lobe (three lobes) design as shown in FIG. 5 or a quad-lobed (four lobes) design as shown in FIG. 6. For the sake of discussion the feature machined on the ID of the diaphragm ring is considered a “female” connector 305. Attached or machined into compressor impeller 42 is a matching polygon shape, similar in design with the same number of lobes. This matching polygon shape is fabricated on the OD (outer diameter) of the compressor impeller hub 313, and it is symmetrical about the centerline. The dimensions of the matching polygon shape are minimally reduced from the dimensions of female connector 305 allowing the machined shape on the OD of the compressor impeller hub 313 to fit within female connector 305 in a snug or slightly loose manner. For the sake of description the shape machined on the OD of the compressor impeller hub 313 is considered a “male” connector 306. Male connector 306 and female connector 305 may be reversed (male on the diaphragm 303 and female on the compressor impeller hub 313) if beneficial to the design integration.

The interlocking fit between male connector 306 and female connector 305 allows for the transmission of torque between generator/motor section 10 and compressor/combustor section 30. This is the case during the startup mode when generator/motor section 10 is driving compressor/combustor section 30, and when the turbine is operating in a sustained mode and compressor/combustor section 30 is driving generator/motor section 10. The fit between male connector 306 and female connector 305 allows the two components to move axially relative to each other. This ability to engage and disengage the components by way of the axial motion allows rapid assembly of generator/motor section 10 and compressor/combustor section 30 during the build process of the turbogenerator system and rapid disassembly of generator/motor section 10 from compressor/combustor section 30 for repair. Build experience has demonstrated that the build time to join the two subassemblies together is reduced to seconds compared to 30 minutes to one hour on previous designs. Once generator/motor section 10 is installed and has engaged compressor/combustor section 30, generator/motor section 10 is constrained axially by the interaction of the permanent magnet within the sleeve 12 of generator/motor section 10 and generator stator windings 14. The magnetic interaction is self-centering. That is, the permanent magnet is self-centered axially between the ends of the stator windings 14 and requires no adjustment or secondary axial retention features. The self-centering force increases with increased rotational speed due to the electromechanical interaction that occurs during operation.

The fit between male connector 306 and female connector 305, as previously stated, can be snug or slightly loose, for example, ˜<0.010-inch radial clearance, specifically, between 0.0071 to 0.010 inch radial clearance. The interface between the two mating surfaces requires no secondary lubrication. However, as a result, the mating surfaces can come into direct contact with each other. That contact can result in fretting (wear), at the contact surfaces. The (micro) fretting can be reduced or eliminated by employing various techniques such as: 1) using dissimilar materials for the male and female features such as high nickel alloys and stainless steel, and/or carbon alloys, aluminum and titanium 2) applying different types of tribology (wear coatings) or plating to one (1) or both of the contacting connectors such as molybdenum disulfide, thin dense chrome, or Polytetrafluoroethylene (PTFE) 3) vary the dimensions of the connectors and the resulting fit to optimize the contact relationship during operation; or 4) employ all or a combination of the previous methods of reducing the fretting. In a currently preferred embodiment, mating features are made of Nitronic 40™ and PH13-8Mo stainless steel.

Incorporating flexible disk shaft 76 into the turbogenerator system has benefits in addition to the ones already described. As higher performance is required from the turbogenerator system, gas temperatures generated in the combustor must increase. This gas temperature increase will affect the metal temperatures of the surfaces it comes into contact with. Turbine wheel 72, which is being driven at high rpm's by the combustion gas, will experience higher surface temperatures and high bulk temperatures in turbine wheel hub 312. This high rpm operation can produce high tensile stress in turbine wheel hub 312. Some designs that are suitable for lower performing turbogenerator systems have a bore through the turbine wheel hub that, allows a tie bolt to be used to clamp the turbine wheel, bearing rotor, and compressor impeller together in an axial manner. In higher performance designs the bore through the turbine wheel is not desirable due to the increased stresses at the ID of the bore.

These higher than preferred stresses can cause the turbine wheel 72 to have an operational life less than the design life requirements. It is therefore desirable to eliminate the bore from the hub 312 of the turbine wheel 72. Tie bolt 308 can be attached to turbine wheel 72, by various methods, at the centerline of solid turbine wheel hub 312. Tie bolt 308 can then pass through a bore in bearing rotor 74 and a bore in compressor impeller 42. A retainer, such as nut 309, can be used on threaded end 310 of tie bolt 308 opposite the end of the tie bolt attached to turbine wheel 72. Tie bolt 308 thereby clamps the three main components—namely, compressor impeller 42, bearing rotor 74, and turbine wheel 72 together in an axial manner. This method of clamping compressor/combustor section 30 components using tie bolt 308 attached to solid hub 312 of turbine wheel 72 would be impractical or impossible using previous coupling designs connecting the generator/motor section to the compressor/combustor section. That is, in previous designs the head of the tie bolt was attached to one end of the flexible disk shaft and the threaded end of the tie bolt extended through bores in the compressor impeller, rotor bearing, and turbine wheel. Flexible disk shaft 76 described herein accommodates the various above-noted design features and requirements.

Flexible disk shaft 76 has benefits during assembly, disassembly, maintenance, or overhaul. Flexible disk shaft 76 allows generator/motor section 10 to be removed from or installed into the turbogenerator system as previously described, or allows generator stator windings 14 and related components to be removed along with generator/motor section 10 without damaging the flexure coupling. This ease of assembly and disassembly was not available with previous designs. This ease of assembly and disassembly is particulary beneficial if service or replacement of the generator/motor stator and housing is required.

The device disclosed may be incorporated into turbogenerator systems with various power ratings, and/or various numbers of compressor and/or turbine stages.

What is claimed is:

1. A compound shaft comprising:
(a) a quill shaft having a first flexible disk at a first end thereof and a second flexible disk at a second end thereof;
(b) a first stiff shaft, said first flexible disk interference fit with said first stiff shaft;
(c) a second stiff shaft, said second stiff shaft having an end comprising a first multi-lobe male or female connector; and
(d) a second multi-lobe female or male connector on said second flexible disk drivingly mating with said first multi-lobe male or female connector.

2. A compound shaft according to claim 1, wherein said second stiff shaft comprises a compressor impeller hub.

3. A compound shaft according to claim 2, wherein said second multi-lobe connector is attached to said compressor impeller hub.

4. A compound shaft according to claim 2, wherein said second multi-lobe connector is formed on said compressor impeller hub.

5. A compound shaft according to claim 1 further comprising a ring attached to said second flexible disk, said first multi-lobe connector is formed on the inside of said ring.

6. A compound shaft according to claim 1, wherein said first stiff shaft comprises a hollow sleeve.

7. A compound shaft according to claim 6, wherein said hollow shaft has a magnet mounted therein.

8. A compound shaft according to claim 1, wherein said second stiff shaft comprises:
(a) a hollow compressor impeller hub, a hollow bearing rotor; and a solid turbine wheel hub; and
(b) a tie bolt attached to said solid turbine wheel hub, said hollow compressor impeller hub, and said hollow bearing rotor mounted on said tie bolt.

9. A turbogenerator comprising a compound shaft according to claim 1.

10. A compound shaft for a permanent magnet turbogenerator, said compound shaft comprising:
(a) a quill shaft having a first flexible disk at a first end thereof and a second flexible disk at a second end thereof;
(b) said turbogenerator having a first stiff shaft, said first flexible disk interference fit with said first stiff shaft.
(c) said turbogenerator having a second stiff shaft, said second stiff shaft having an end comprising a first multi-lobe male or female connector; and
(d) a second multi-lobe female or male connector on said second flexible disk drivingly mating with said first multi-lobe male or female connector.

11. A compound shaft according to claim 10, wherein said first stiff shaft is a nonmagnetic hollow sleeve;
(a) a permanent magnet mounted within said hollow nonmagnetic sleeve; and
(b) said turbogenerator having a stator mounted coaxially about said nonmagnetic hollow sleeve;
(c) whereby electromechanical interaction between said permanent magnet and said stator provide self-centering forces on said permanent magnet urging said permanent magnet to a desired axial position within said stator.

12. A method of making a compound shaft comprising the steps of:
(a) providing a quill shaft having a first flexible disk at a first end thereof and a second flexible disk at a second end thereof;
(b) providing a first stiff shaft;
(c) attaching said first flexible disk by an interference fit with said first stiff shaft;
(c) providing a second stiff shaft;
(d) providing on said second stiff shaft having an end comprising a first multi-lobe male or female connector; and
(d) providing a second multi-lobe female or male connector on said second flexible disk drivingly mating with said first multi-lobe male or female connector.

13. A method of making a compound shaft according to claim 12, wherein said step of providing a second stiff shaft comprises providing a compressor impeller hub.

14. A method of making a compound shaft according to claim 13, wherein said step of providing said second multi-lobe connector on said second stiff shaft comprises attaching said second multi-lobe connector on said compressor impeller hub.

15. A method of making a compound shaft according to claim 13, wherein said step of providing said second multi-lobe connector on said second stiff shaft comprises forming said second multi-lobe connector on said compressor impeller hub.

16. A method of making a compound shaft according to claim 12 further comprising the steps of:
(a) providing a ring on said second flexible disk; and
(b) providing said first multi-lobe connector on said ring.

17. A method on making a compound shaft according to claim 12, wherein said step of providing a first stiff shaft comprises providing a hollow sleeve.

18. A method of making compound shaft according to claim 17, comprising the step of providing a permanent magnet in said hollow sleeve.

19. A method of making compound shaft according to claim 12, wherein said step of providing said second stiff shaft comprises the steps of:
(a) providing a hollow compressor impeller hub, a hollow bearing rotor;
and a solid turbine wheel hub;
(b) providing a tie bolt;
(c) attaching said tie bolt to said solid turbine wheel hub;
(d) mounting said hollow compressor impeller hub, and said hollow bearing rotor mounted on said tie bolt.

20. A method of making a compound shaft for a permanent magnet turbogenerator, said compound shaft comprising the steps of:
(a) providing a quill shaft having a first flexible disk at a first end thereof and a second flexible disk at a second end thereof;
(b) providing said turbogenerator with a first stiff shaft;
(c) attaching said first flexible disk by an interference fit with said first stiff shaft;
(d) providing said turbogenerator with a second stiff shaft;
(e) providing on said second stiff shaft an end comprising a first multi-lobe male or female connector; and
(f) providing a second multi-lobe female or male connector on said second flexible disk drivingly mating with said first multi-lobe male or female.

21. A method of making a compound shaft according to claim 20, wherein said step of providing a first stiff shaft comprises the steps of:
(a) providing a nonmagnetic hollow sleeve;
(b) providing a permanent magnet within said hollow nonmagnetic sleeve;
(c) providing said turbogenerator with a stator; and
(d) coaxially mounting said stator about said nonmagnetic hollow sleeve;
(e) whereby electromechanical interaction between said permanent magnet and said stator provide self-centering forces on said permanent magnet urging said permanent magnet to a desired axial position within said stator.

22. A method of using a compound shaft according to claim 12, comprising the step of rotating the compound shaft at over about 20,000 rpm.

23. A compound shaft comprising:
(a) a quill shaft having a first flexible disk at a first end thereof and a second flexible disk at a second end thereof;
(b) a first shaft, said first flexible disk interference fit with said first shaft;
(c) a second shaft, said second shaft having an end comprising a first multi-lobe male or female connector; and
(d) a second multi-lobe female or male connector on said second flexible disk drivingly mating with said first multi-lobe male or female connector.

24. A compound shaft according to claim 23, wherein said second shaft comprises a compressor impeller hub.

25. A compound shaft according to claim 24, wherein said second multi-lobe connector is attached to said compressor impeller hub.

26. A compound shaft according to claim 24, wherein said second multi-lobe connector is formed on said compressor impeller hub.

27. A compound shaft according to claim 23 further comprising a ring attached to said second flexible disk, said first multi-lobe connector is formed on the inside of said ring.

28. A compound shaft according to claim 23, wherein said first shaft comprises a hollow sleeve.

29. A compound shaft according to claim 28, wherein said hollow shaft has a magnet mounted therein.

30. A compound shaft according to claim 23, wherein said second shaft comprises:
(a) a hollow compressor impeller hub, a hollow bearing rotor; and a solid turbine wheel hub; and
(b) a tie bolt attached to said solid turbine wheel hub, said hollow compressor impeller hub, and said hollow bearing rotor mounted on said tie bolt.

31. A turbogenerator comprising a compound shaft according to claim 23.

32. A compound shaft for a permanent magnet turbogenerator, said compound shaft comprising:
(a) a quill shaft having a first flexible disk at a first end thereof and a second flexible disk at a second end thereof;
(b) said turbogenerator having a first shaft, said first flexible disk interference fit with said first shaft.
(c) said turbogenerator having a second shaft, said second shaft having an end comprising a first multi-lobe male or female connector; and
(d) a second multi-lobe female or male connector on said second flexible disk drivingly mating with said first multi-lobe male or female connector.

33. A compound shaft according to claim 32, wherein said first shaft is a nonmagnetic hollow sleeve;
(a) a permanent magnet mounted within said hollow nonmagnetic sleeve; and
(b) said turbogenerator having a stator mounted coaxially about said nonmagnetic hollow sleeve;
(c) whereby electromechanical interaction between said permanent magnet and said stator provide self-centering forces on said permanent magnet urging said permanent magnet to a desired axial position within said stator.

34. A method of making a compound shaft comprising the steps of:
(a) providing a quill shaft having a first flexible disk at a first end thereof and a second flexible disk at a second end thereof
(b) providing a first shaft;
(c) attaching said first flexible disk by an interference fit with said first shaft;
(d) providing a second shaft;
(e) providing on said second shaft having an end comprising a first multi-lobe male or female connector; and
(f) providing a second multi-lobe female or male connector on said second flexible disk drivingly mating with said first multi-lobe male or female connector.

35. A method of making a compound shaft according to claim 34, wherein said step of providing a second shaft comprises providing a compressor impeller hub.

36. A method of making a compound shaft according to claim 35, wherein said step of providing said second multi-lobe connector on said second shaft comprises attaching said second multi-lobe connector on said compressor impeller hub.

37. A method of making a compound shaft according to claim 35, wherein said step of providing said second multi-lobe connector on said second shaft comprises forming said second multi-lobe connector on said compressor impeller hub.

38. A method of making a compound shaft according to claim 34 further comprising the steps of:
(a) providing a ring on said second flexible disk; and
(b) providing said first multi-lobe connector on said ring.

39. A method on making a compound shaft according to claim 34, wherein said step of providing a first shaft comprises providing a hollow sleeve.

40. A method of making compound shaft according to claim 39, comprising the step of providing a permanent magnet in said hollow sleeve.

41. A method of making compound shaft according to claim 34, wherein said step of providing said second shaft comprises the steps of:
(a) providing a hollow compressor impeller hub, a hollow bearing rotor; and a solid turbine wheel hub;
(b) providing a tie bolt;
(c) attaching said tie bolt to said solid turbine wheel hub;
(d) mounting said hollow compressor impeller hub, and said hollow bearing rotor mounted on said tie bolt.

42. A method of making a compound shaft for a permanent magnet turbogenerator, said compound shaft comprising the steps of:
(a) providing a quill shaft having a first flexible disk at a first end thereof and a second flexible disk at a second end thereof;
(b) providing said turbogenerator with a first shaft;
(c) attaching said first flexible disk by an interference fit with said first shaft;
(c) providing said turbogenerator with a second shaft;
(d) providing on said second shaft an end comprising a first multi-lobe male or female connector; and
(e) providing a second multi-lobe female or male connector on said second flexible disk drivingly mating with said first multi-lobe male or female.

43. A method of making a compound shaft according to claim 20, wherein said step of providing a first shaft comprises the steps of:
(a) providing a nonmagnetic hollow sleeve;
(b) providing a permanent magnet within said hollow nonmagnetic sleeve;
(c) providing said turbogenerator with a stator; and
(d) coaxially mounting said stator about said nonmagnetic hollow sleeve;
(e) whereby electromechanical interaction between said permanent magnet and said stator provide self-centering forces on said permanent magnet urging said permanent magnet to a desired axial position within said stator.

44. A method of using a compound shaft according to claim 34, comprising the step of rotating the compound shaft at over about 20,000 rpm.
